(19) United States
(12) Patent Application Publication
(10) Pub. No.: US 2011/0040902 A1
(43) Pub. Date: Feb. 17, 2011

(54) COMPENSATION ENGINE FOR TRAINING DOUBLE DATA RATE DELAYS

(76) Inventor: Oswin E. Housty, Austin, TX (US)

Correspondence Address: MEYERTONS, HOOD, KIVLIN, KOWERT & GOETZEL (AMD), P.O. BOX 398, AUSTIN, TX, 78767-0398, US

(21) Appl. No.: 12/540,850

(22) Filed: Aug. 13, 2009

(51) Int. Cl. G06F 3/00

(52) U.S. Cl. 710/15; 710/61

(57) ABSTRACT

A memory subsystem configured to perform event-driven training. The memory subsystem includes a memory, a memory controller coupled to the memory, and a monitoring unit coupled to the memory controller. The monitoring unit is configured to monitor at least one parameter of the memory subsystem, determine whether at least one parameter is within a specified range, and provide an indication to the memory controller if at least one parameter is not within the specified range. The memory controller is configured to perform a training procedure responsive to receiving the indication. Performing the training procedure includes the memory controller performing at least one write to memory, at least one read from memory, and adjusting a delay for one or more signals conveyed between the memory controller and the memory.

### BACKGROUND OF THE INVENTION

1. Field of the Invention

This invention relates to computer systems, and more particularly, to the training of timing delays in double data rate (DDR) memory subsystems.

2. Description of the Related Art

Double data rate (DDR, DDR2, and DDR3) memory achieves high memory bandwidth by utilization of both the rising and falling edges of a clock signal. Due to the fact that both clock edges are used, timing margins may be smaller for DDR memories than for memory types in which only a single clock signal is used. In order to guarantee the timing of signals associated with DDR memories, a training procedure may be performed.

Training may include the performing of various reads and writes and the exercising of various control signals, while synchronizing various signals with each other. These signals include a memory clock signal, a data strobe signal (DQS), various control signals (e.g., read enable, write enable) and data signals. A training procedure may include synchronizing a DQS signal with the memory clock signal, a receive enable signal to a DQS signal, read data signals to a DQS signal, and write data signals to a DQS signal. Training may also include introducing some delays are introduced for signals transmitted between a memory controller and memory.

In computer systems utilizing DDR memory, a training procedure may be performed during system start up. Various signal transmissions may be conducted between a memory controller and memory in order to synchronize the signals as discussed above.

### SUMMARY OF THE INVENTION

A memory subsystem is disclosed. In one embodiment, the memory subsystem includes a memory, a memory controller coupled to the memory, and a monitoring unit coupled to the memory controller. The monitoring unit is configured to monitor at least one parameter of the memory subsystem, determine whether at least one parameter is within a specified range, and provide an indication to the memory controller if at least one parameter is not within the specified range. The memory controller is configured to perform a training procedure responsive to receiving the indication. Performing the training procedure includes the memory controller performing at least one write to memory, at least one read from memory, and adjusting a delay for one or more signals conveyed between the memory controller and the memory.

In one embodiment, a method comprises a monitoring unit monitoring at least one parameter of a memory subsystem, the memory subsystem including a memory and a memory controller. The method further comprises the monitoring unit determining whether the at least one parameter is within a specified range. The method further includes the monitoring unit providing an indication to the memory controller if the at least one parameter is not within the specified range. The memory controller may then perform a training procedure responsive to receiving the indication, wherein performing the training procedure includes the memory controller performing at least one write to memory, at least one read from memory, and adjusting a delay for one or more signals conveyed between the memory controller and the memory.

A computer system is also contemplated. In one embodiment, the computer system includes a processor, a memory controller coupled to the processor, a memory coupled to the memory controller, and a monitoring unit. The monitoring unit is configured to monitor at least one parameter associated with the memory, determine whether the parameter is within a specified range, and provide an indication to the memory controller if the at least one parameter is not within the specified range. Responsive to receiving the indication, the memory controller is configured to perform a training procedure. The training procedure may include the memory controller performing at least one write to memory, at least one read from memory, and adjusting a delay for one or more signals conveyed between the memory controller and the memory.

### BRIEF DESCRIPTION OF THE DRAWINGS

Other aspects of the invention will become apparent upon reading the following detailed description and upon reference to the accompanying drawings in which:

FIG. 1 is a block diagram of one embodiment of a computer system;

FIG. 2 is a block diagram of one embodiment of a memory subsystem within a computer system;

FIG. 3 is a block diagram of one embodiment of a monitoring unit;

FIG. 4 is a timing diagram illustrating the various signals to be synchronized during a training procedure in one embodiment of a memory subsystem; and

FIG. 5 is a flow diagram illustrating a method of operating one embodiment of a memory subsystem.

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications, equivalents, and alternatives falling within the spirit and scope of the present invention as defined by the appended claims.

### DETAILED DESCRIPTION OF THE INVENTION

### Computer System

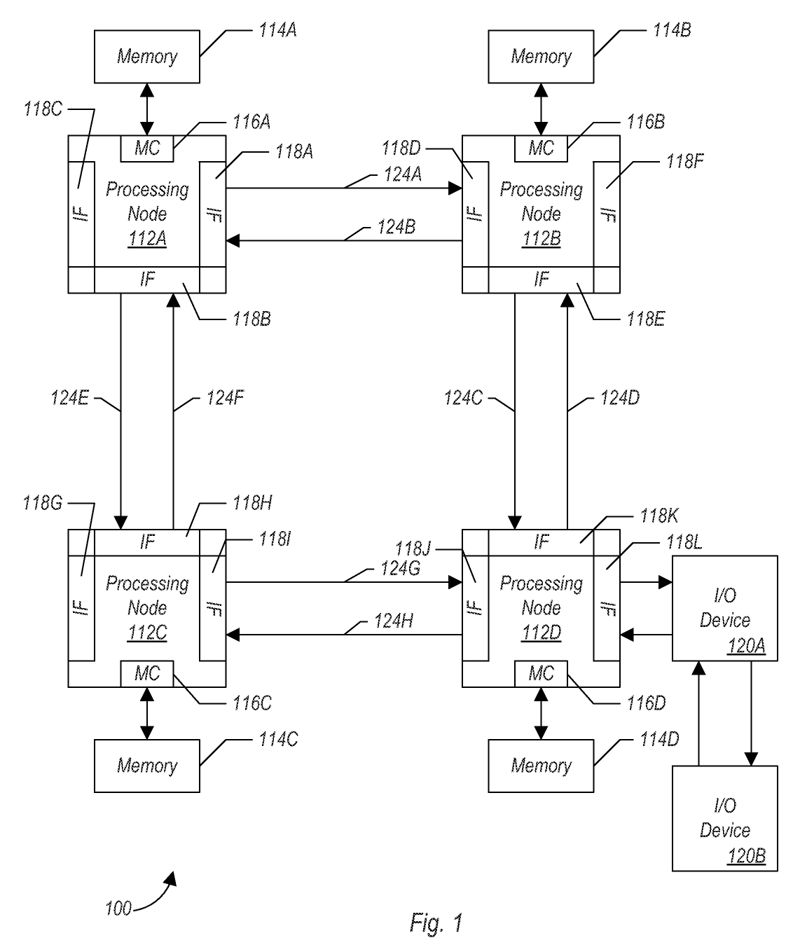

Turning now to FIG. 1, an embodiment of a computer system 100 is shown. In the embodiment of FIG. 1, computer system 100 includes several processing nodes 112A, 112B, 112C, and 112D. Each processing node is coupled to a respective memory 114A-114D via a memory controller 116A-116D included within each respective processing node 112A-112D. Additionally, processing nodes 112A-112D include interface logic used to communicate between the processing nodes 112A-112D. For example, processing node 112A includes interface logic 118A for communicating with processing node 112B, interface logic 118B for communicating with processing node 112C, and a third interface logic 118C for communicating with yet another processing node (not shown). Similarly, processing node 112B includes interface logic 118D, 118E, and 118F; processing node 112C includes interface logic 118G, 118H, and 118I; and processing node 112D includes interface logic 118J, 118K, and 118L. Processing node 112D is coupled to communicate with a plurality of input/output devices (e.g. devices 120A-120B in a daisy chain configuration) via interface logic 118L. Other processing nodes may communicate with other I/O devices in a similar fashion.

Processing nodes 112A-112D implement a packet-based link for inter-processing node communication. In the present embodiment, the link is implemented as sets of unidirectional lines (e.g. lines 124A are used to transmit packets from processing node 112A to processing node 112B and lines 124B are used to transmit packets from processing node 112B to processing node 112A). Other sets of lines 124C-124H are used to transmit packets between other processing nodes as illustrated in FIG. 1. Generally, each set of lines 124 may include one or more data lines, one or more clock lines corresponding to the data lines, and one or more control lines indicating the type of packet being conveyed. The link may be operated in a cache coherent fashion for communication between processing nodes or in a noncoherent fashion for communication between a processing node and an I/O device (or a bus bridge to an I/O bus of conventional construction such as the Peripheral Component Interconnect (PCI) bus or Industry Standard Architecture (ISA) bus). Furthermore, the link may be operated in a non-coherent fashion using a daisy-chain structure between I/O devices as shown. It is noted that a packet to be transmitted from one processing node to another may pass through one or more intermediate nodes. For example, a packet transmitted by processing node 112A to processing node 112D may pass through either processing node 112B or processing node 112C as shown in FIG. 1. Any suitable routing algorithm may be used. Other embodiments of computer system 100 may include more or fewer processing nodes then the embodiment shown in FIG. 1.

Generally, the packets may be transmitted as one or more bit times on the lines 124 between nodes. A bit time may be the rising or falling edge of the clock signal on the corresponding clock lines. The packets may include command packets for initiating transactions, probe packets for maintaining cache coherency, and response packets from responding to probes and commands.

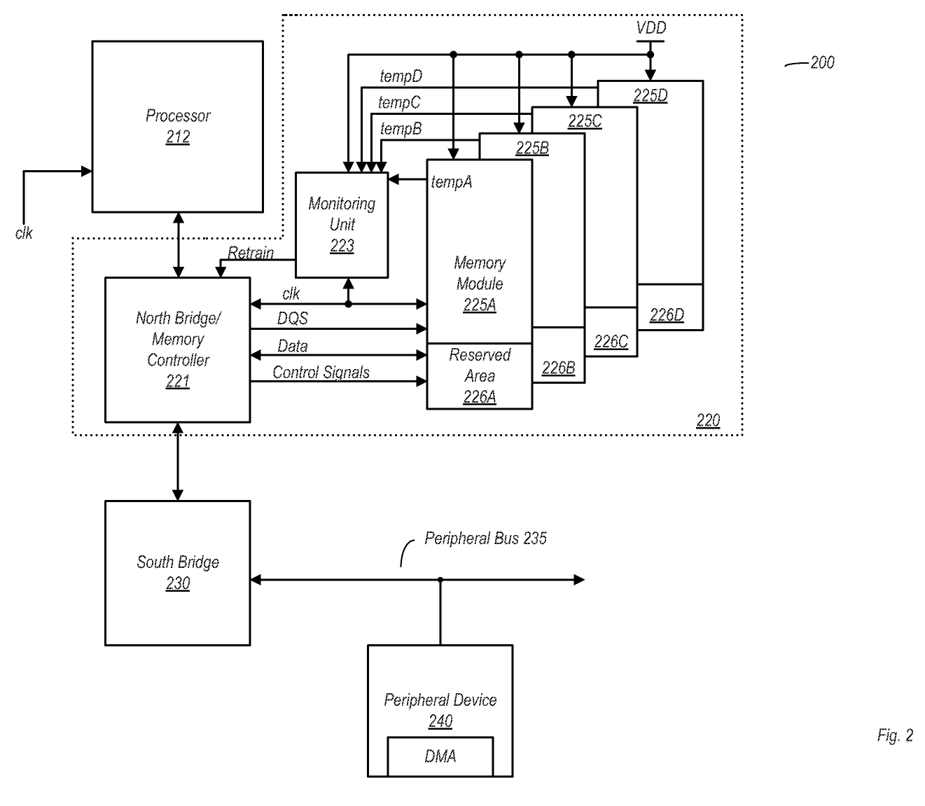

Processing nodes 112A-112D, in addition to a memory controller and interface logic, may include one or more processors. Broadly speaking, a processing node comprises at least one processor and may optionally include a memory controller for communicating with a memory and other logic as desired. More particularly, each processing node 112A-112D may comprise one or more copies of processor 10 as shown in FIG. 1 (e.g. including various structural and operational details shown in FIGS. 2-5). One or more processors may comprise a chip multiprocessing (CMP) or chip multithreaded (CMT) integrated circuit in the processing node or forming the processing node, or the processing node may have any other desired internal structure.

Memories 114A-114D may comprise any suitable memory devices. For example, a memory 114A-114D may comprise one or more RAMBUS DRAMs (RDRAMs), synchronous DRAMs (SDRAMs), DDR SDRAM, static RAM, etc. The address space of computer system 100 is divided among memories 114A-114D. Each processing node 112A-112D may include a memory map used to determine which addresses are mapped to which memories 114A-114D, and hence to which processing node 112A-112D a memory request for a particular address should be routed. In one embodiment, the coherency point for an address within computer system 100 is the memory controller 116A-116D coupled to the memory storing bytes corresponding to the address. In other words, the memory controller 116A-116D is responsible for ensuring that each memory access to the corresponding memory 114A-114D occurs in a cache coherent fashion. Memory controllers 116A-116D may comprise control circuitry for interfacing to memories 114A-114D. Additionally, memory controllers 116A-116D may include request queues for queuing memory requests. In some embodiments, memory controllers 116A-116D may be configured to perform a training procedure in order to set delays and synchronize certain signals transmitted to or received from a memory coupled thereto.

Generally, interface logic 118A-118L may comprise a variety of buffers for receiving packets from the link and for buffering packets to be transmitted upon the link. Computer system 100 may employ any suitable flow control mechanism for transmitting packets. For example, in one embodiment, each interface logic 118 stores a count of the number of each type of buffer within the receiver at the other end of the link to which that interface logic is connected. The interface logic does not transmit a packet unless the receiving interface logic has a free buffer to store the packet. As a receiving buffer is freed by routing a packet onward, the receiving interface logic transmits a message to the sending interface logic to indicate that the buffer has been freed. Such a mechanism may be referred to as a “coupon-based” system.

I/O devices 120A-120B may be any suitable I/O devices. For example, I/O devices 120A-120B may include devices for communicating with another computer system to which the devices may be coupled (e.g. network interface cards or modems). Furthermore, I/O devices 120A-120B may include video accelerators, audio cards, hard or floppy disk drives or drive controllers, SCSI (Small Computer Systems Interface) adapters and telephony cards, sound cards, and a variety of data acquisition cards such as GPIB or field bus interface cards. Furthermore, any I/O device implemented as a card may also be implemented as circuitry on the main circuit board of the system 100 and/or software executed on a processing node. It is noted that the term “I/O device” and the term “peripheral device” are intended to be synonymous herein.

### Memory Subsystem:

Turning now to FIG. 2, a block diagram of one embodiment of a memory subsystem within a computer system is shown. In the embodiment shown, computer system 200 includes a memory subsystem 220 coupled to a processor 212 and South Bridge 230. Processor 212 may be equivalent to any one of processing nodes 112A-D shown in FIG. 1, or may be any other type of processor. Furthermore, processor 212 may be but one of a number of processors present in computer system 200.

South Bridge 230 may be an I/O controller hub coupled to one or more peripheral buses of varying types. In the embodiment shown, South Bridge 230 is coupled to peripheral bus 235, although other peripheral buses may also be present. These peripheral buses may include, but are not limited to, a universal serial bus (USB), an IEEE 1394 (Firewire) bus, a peripheral component interconnect (PCI) bus, a HyperTransport bus, and so forth.

In this embodiment, a peripheral device 240 is coupled to peripheral bus 235. Peripheral device 240 may be one of a number of different types of devices, including the I/O devices 120A-120B discussed above. More particularly, peripheral device 240 may be one of a number of different peripheral devices including (but not limited to) a keyboard, mouse, or other input device, a printer, a digital camera, and so forth. Broadly speaking, peripheral device 240 may be any type of peripheral device that may be coupled to a peripheral bus. In the embodiment shown, peripheral device 240 is configured to direct memory access (DMA), thereby enabling it to access the memory comprising memory modules 225A-225D without intervention from processor 212.

Memory subsystem 220 in the embodiment shown includes a North Bridge/Memory Controller 221 (hereinafter ‘memory controller 221’) coupled to both processor 212 and South Bridge 230. Memory subsystem 220 also includes a memory including a plurality of memory modules 225A-225D in this embodiment. The exact configuration of the memory may vary from one embodiment to the next. For example, a memory made up of a greater or lesser number of memory modules than shown in this embodiment is contemplated. Furthermore, a memory that uses no memory modules, but instead utilizes memory chips soldered directly to a motherboard is also possible and contemplated. With regard to embodiments that utilize memory modules, it is noted that such memory modules may be hot-pluggable. Computer systems utilizing hot-pluggable memory modules may be configured to detect the change in the size of the address space resulting from the insertion or removal of a memory module and adjust accordingly.

It should be noted that while memory controller 221 is shown as unit separate from processor 212 in the embodiment shown, embodiments are also possible wherein memory controller 221 is integrated into a processor. For example, each of the processors shown in the embodiment of FIG. 1 includes an integrated memory controller 116. Memory controller 221 may also be integrated into a processor such as processor 212 shown in the embodiment of FIG. 2. Furthermore, while memory controller 221 also incorporates the functionality of a north bridge device in this embodiment, embodiments wherein these functions are separated are also possible, and thus the functions of either (or both) may be integrated into a processor.

The type of memory used to implement memory modules 225A-225D may also vary from one embodiment to the next. In one embodiment, the memory implemented on memory modules 225A-225D may be a double data rate (DDR) memory, wherein data may be transmitted in synchronization with both a rising and a falling edge of a memory clock signal. Memory modules 225A-225D may also be based on successors to DDR, DDR2 or DDR3. Single data rate memories (i.e. synchronized to only a single clock edge) are also possible and contemplated for use in memory modules 225A-225D.

In the embodiment shown, memory controller 221 is coupled to memory modules 225A-225D by a plurality of signal paths. Memory controller 221 may be configured to receive a clock signal (clk) that is also provided to memory modules 225A-225D (this clock is also provided to processor 212 in the embodiment shown). Memory controller 221 may also be configured to provide a data strobe signal (DQS), and various control signals (e.g., read and write enable signals, column address strobe and row address strobe signals, etc.) to each of memory modules 225A-225D. A bi-directional data bus is also coupled between memory controller 221 and memory modules 225A-225D. It should be noted that while the data bus and the control signal bus coupled between memory controller 221 and memory modules 225A-225D are shown as single lines, this is not to imply that the connections in actual practice constitute singular signal paths. Each of the connections shown in this drawing as well as the other drawings discussed herein may include a plurality of signal paths (e.g., a 32-bit data bus having 32 signal paths, a control bus having separate signal lines for the read enable and write enable signals, etc.), and these signal paths may be single-ended signal paths or differential signal paths.

Memory controller 221 may be configured to perform a training procedure in order to synchronize various signals transmitted to and received from memory modules 225A-225D. An initial training procedure may be performed at system boot up, although computer system 200 in this embodiment is configured to allow the training procedure to be performed again, as desired, subsequent beginning operation. The training procedure performed by memory controller 221 may include aligning the edges of various signals. For example, a training procedure may include aligning the edges of the DQS signal with system clock signal (‘clk’). The training may also include aligning data signals to the edges of the DQS signal during reads from and writes to the memory comprising memory modules 225A-225D.

The reads and writes performed by memory controller 221 may utilize areas of memory that are reserved exclusively for use during the training procedure. In the embodiment shown, each of memory modules 225A-225D includes a corresponding reserved area, 226A-226D, respectively. The reserved areas of memory 226A-226D may each include a plurality of memory addresses, and may be utilized exclusively for performing reads and writes during training operations, and may thus be unavailable for use by during normal (i.e. non-training) operations. Accordingly, memory controller 221 in the embodiment shown is configured to block access to the addresses of the reserved areas 226A-226D by other devices, including processor 212 and any DMA-enabled peripheral devices (such as peripheral device 240) during normal operation of computer system 200.

It is noted that the organization of the reserved areas of memory may vary from one embodiment to the next. In the embodiment shown, the reserved area for each of the memory modules may comprise a contiguous block of memory. In other embodiments, certain addresses in non-contiguous locations may be specified as reserved, while in other embodiments, a series of contiguous blocks may be specified as reserved. Embodiments are also possible and contemplated wherein the reserved area is located on a single memory module. In general, the area of memory reserved for use during the performance of the training procedure may be organized in any suitable manner for a particular implementation.

Memory subsystem 220 may also include monitoring unit 223. In the embodiment shown, monitoring unit 223 is implemented as hardware. However, embodiments wherein the functions of monitoring unit 223 are performed by software (e.g., by instructions executing on processor 212 or memory controller 221), firmware, or any combination of hardware, software, and/or firmware, are also possible and contemplated.

Monitoring unit 223 in the embodiment shown is coupled to receive the clock signal (clk) provided to memory control 221 and processor 212, as well as a supply voltage VDD and temperature information, tempA-tempD, from memory modules 225A-225D, respectively. Based on these parameters and one or more predetermined values or ranges, monitoring unit 223 may be configured to indicate when a training procedure is to be performed. An initial training procedure may be performed during a boot-up of computer system 200. However, computer system 200 may also be configured to enable a training procedure to be performed subsequent to system boot up. In this particular embodiment, monitoring unit 223 may be configured to monitor the supply voltage and frequency of the clock signal provided to memory modules 225A-225D, as well as the temperature of each of the memory modules 225A-225D. In general, monitoring unit 223 may be configured to monitor any number of different parameters associated with the memory comprising memory modules 225A-225D. The monitored values may be compared to predetermined values defining a range of values. If one or more of the parameters falls outside of a specified range, monitoring unit 223 may be configured to assert a signal (shown here as the ‘retrain’ signal). Monitoring unit 223 may also be configured to assert the retrain signal on a periodic basis. Responsive to receiving the retrain signal, memory controller 221 may be configured to assert an interrupt to processor 212. Processor 212 may invoke an interrupt handler responsive to the assertion of the interrupt, wherein the interrupt handler may temporarily suspend accesses to the memory by units other than memory controller 221. Memory controller 221 may then perform the training procedure.

In the embodiment shown, the various parameters monitored by monitoring unit 223 include the supply voltage provided to memory module 225A-225D, the frequency of the clock signal provided to the memory modules, the temperature of the memory modules, and the amount of time elapsed since a previous training procedure was performed. Embodiments that monitor additional parameters (e.g., access rates, etc.) are also possible and contemplated. Monitoring unit 223 may be configured to assert the retrain signal based on one or more of these parameters being out of a specified range. For example, in embodiments wherein periodic training is to be performed, monitoring unit 223 may be configured to assert the retrain signal if the amount of time elapsed since the last training meets or exceeds a specified duration. In another example, monitoring unit 223 may be configured to assert the retrain signal if the supply voltage deviates by a certain amount from a previously determined supply voltage, which may be caused by the insertion or removal of a hot-pluggable memory module into memory subsystem 220. Additional details of an embodiment of a monitoring unit 223 will now be discussed in further detail.

### Monitoring Unit:

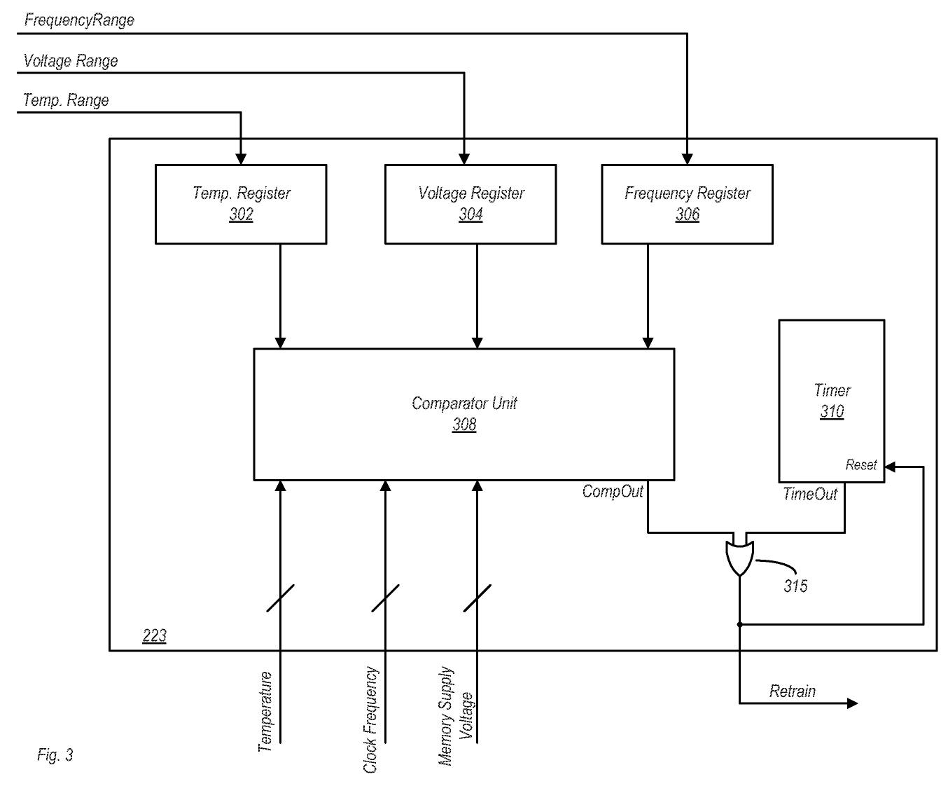

FIG. 3 is a block diagram of one embodiment of monitoring unit 223. In the embodiment shown, monitoring unit 223 includes a temperature register 302, a voltage register 304, and a frequency register 306, each of which is coupled to a comparator unit 308. The embodiment of monitoring unit 223 shown in FIG. 3 also includes a timer 310, and an OR gate 315 coupled to receive as inputs signals from time 310 and comparator unit 308.

Temperature register 302 in the embodiment shown is configured to store temperature information. More particularly, temperature register may store information regarding a range of temperatures, or one or more temperature thresholds. The information stored in temperature register 302. Temperature information may be input into temperature register from an external source, e.g., via a processor, a memory controller, or other source. Comparator unit 308 may access the temperature information stored in temperature register 302. Comparator unit 308 may also be coupled receive temperature readings from memory (e.g., from each of one or more memory modules 225A-225D). Based on the received temperature readings, comparator unit 308 may determine if any of the temperature readings received from memory are outside a temperature range (e.g., exceeds a temperature threshold) specified by the temperature information stored in temperature register 302. Comparator unit 308 may assert the CompOut signal if it determines that a temperature reading received from memory is outside of the specified range. The responsive to receive the asserted CompOut signal, OR gate 315 may assert the retrain signal, which may then be provided to memory controller 221 in order to initiate a training operation.

Voltage register 304 is configured to store voltage information in the embodiment shown. More particularly, voltage register 304 may store information indicating a range of voltages or one or more voltage threshold values. Comparator 308 may access voltage register 304 in order to compare the information stored therein with memory supply voltage information received through the shown input. Comparator unit 308 may compare the received memory supply voltage with the voltage range or threshold value information stored in voltage register 308 in order to determine if the memory supply voltage is within a specified range. If the voltage is not within the specified range, comparator unit 308 may then assert the CompOut signal, thereby causing the retrain signal to be asserted by OR gate 315.

Responsive to a training procedure initiated due to a voltage comparison, the voltage information stored in voltage register 304 may be updated. For example, if the system including monitoring unit 223 supports hot pluggable memory modules, the insertion of an additional memory module may result in additional loading on the power supply providing power to memory. As a result the supply voltage may vary slightly from its value prior to insertion of the hot pluggable memory module. Accordingly, the voltage range or threshold information stored in voltage register 304 may be update responsive to the change in voltage resulting from a change in supply voltage resulting from a change in power supply loading.

Frequency register 306 may store information regarding a range of frequencies for a clock signal that is provided to the memory. The frequency information stored in frequency register 306 may be accessed by comparator unit 308, and compared with a received clock frequency. If the clock frequency is not within a range of frequencies specified by the information stored in frequency register 306, comparator unit 308 may assert the CompOut signal, which thereby causing the retrain signal to be asserted by OR gate 315. Similar to voltage register 304, the frequency range information stored in frequency register 306 may be updated responsive to system changes that may affect the frequency of the clock signal.

As previously noted, monitoring unit 223 in the embodiment shown also includes a timer 310. The timer 310 may be used in embodiments when it is desirable to periodically perform the training procedure. Accordingly, timer 310 may assert a TimeOut signal responsive to determining that a predetermined period has elapsed since a previous instance of the training procedure was performed. The assertion of the TimeOut signal results in the assertion of the retrain signal by OR gate 315 in the embodiment shown.

In this particular embodiment, a reset input of timer 310 is coupled to receive the retrain signal. Thus, when the retrain signal is asserting in this embodiment, timer 310 is reset. Accordingly, the embodiment of monitoring unit 223 shown in FIG. 3 is configured to perform a reset either once for each predetermined time period or when comparator unit 308 determines that one of the monitored parameters (voltage, frequency, and temperature in this embodiment) is no longer within a specified range. In other embodiments, monitoring unit 223 may be configured to perform the training procedure within a given time interval indicated by timer 310 regardless of whether the training procedure has also been performed within that time interval responsive to a comparison operation performed by comparator unit 308. Furthermore, embodiments are also possible and contemplated wherein periodic training operations are not performed, or wherein periodic training procedures can be enabled or disabled according to the desire of a user or other inputs.

As previously noted, the particular parameters monitored to determine whether or not a training procedure is to be performed may vary from one embodiment to the next. In some embodiments, multiple parameters may be monitored, with a training procedure performed if any one of the parameters is out of range. For example, voltage, frequency, and temperature may all be monitored in the embodiment shown, as well as the time elapsed since the previous performance of the training procedure. Accordingly, the embodiment shown may ensure that the training procedure is performed at least once in a given time interval according to timer 310, with additional instances of training being performed if any of the parameters compared by comparator unit 308 is out of its specified range. In some embodiments, the parameters to be monitored (including the period for periodic re-training) may be selectable and configurable. For example, an embodiment of monitoring unit 223 may allow for the selection of the voltage, frequency, and periodic parameters to be monitored, while ignoring the temperature parameter. In general, the embodiment of monitoring unit 223 described above is but one of many possible embodiments of a unit that may be used to monitor parameters and indicate to a memory controller whether or not a training operation is to be performed. Other embodiments may monitor different parameters, and/or different combinations of parameters. Accordingly, some embodiments of a monitoring unit 223 may include additional functional units that are not shown here, or may not include each of the functional units shown in FIG. 3.

While the above discussion of monitoring unit 223 is directed to a hardware embodiment, it is again noted that software and firmware embodiments are also possible and contemplated. Such embodiments may provide instructions that may be executed on a system processor, a memory controller, or other system device that performs the various functions of a monitoring unit as discussed herein, as well as any variations falling within the spirit and scope of this disclosure. It is also noted that in hardware embodiments, monitoring unit 223 may be part of another unit (e.g., such as part of memory controller 221). Generally speaking, monitoring unit 223 may be used to implement an event-driven training scheme, wherein the training procedure may be performed based on the occurrence of various events.

### Training Procedure Timing Diagram:

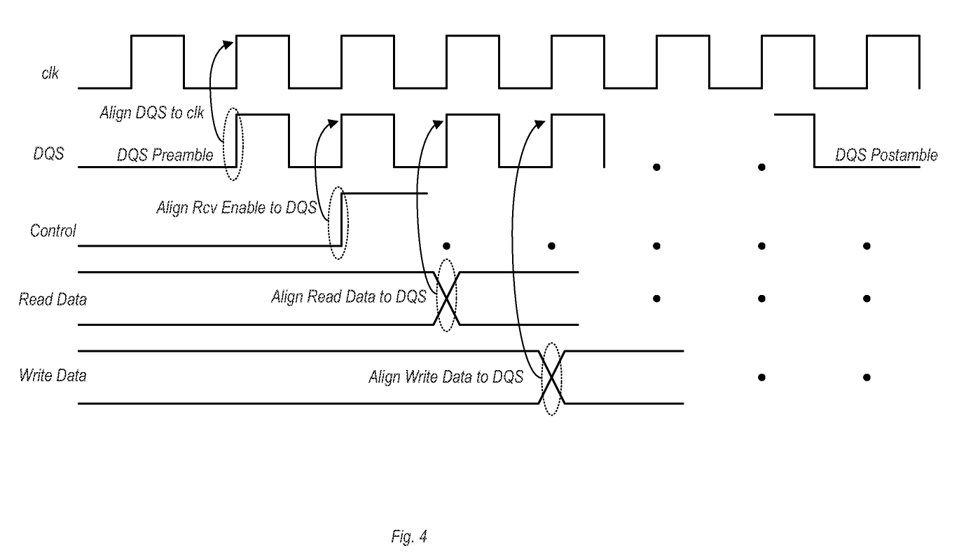

FIG. 4 is a timing diagram illustrating the various signals to be synchronized during a training procedure in one embodiment of a memory subsystem. More particularly, FIG. 4 illustrates some of the signals that may be aligned/synchronized and some of the delays that may be set in a training procedure performed by various embodiments of memory controller 221 discussed above.

In the embodiment shown, a system clock signal (‘clk’) is provided. As shown in FIG. 2, this clock signal may be a system clock signal provided to memory controller 221, each of memory modules 225A-225D, and monitoring unit 223. In general, the system clock signal may be a system clock signal that is provided to both a memory controller and a memory.

Memory controller 221 may also be configured to provide the DQS signal shown in FIG. 4. The DQS signal may be a forwarded clock (or strobe) signal provided by memory controller 221 to memory modules 225A-225D, in conjunction with read and write operations. In the embodiment shown, the DQS signal has a frequency that is equal to that of the system clock signal. Prior to a read or write operation, a delay period referred to as a preamble is provided, as shown in FIG. 4. The training procedure performed by memory controller 221 may include setting the preamble to allow sufficient set up time for the subsequent read and/or write operations to be performed. A similar period referred to as a postamble that follows a memory access (e.g., read or write) may also be set by the training procedure.

The training procedure may also include aligning the edges of the DQS signal to those of the system clock signal. Following the alignment of the edges of the DQS signal to the system clock signal, the training procedure may align the edges of one or more control signals (‘Control’) to the edges of the DQS signal. Only a single control signal is shown here for the sake of simplicity, although it is to be understood that multiple control signals may be present and trained during performance of the training procedure. The control signals may include a read enable signal that is to be asserted for performing a read operation and a write enable signal that is to be asserted for performing a write operation. The control signals may also include a row address strobe (RAS) and column address strobe (CAS) signals.

The training procedure may also include performance of one or more writes of data to memory and one or more reads of data from memory. Accordingly, the data signals written to and read from memory may also have their edges aligned to those of the DQS signal during performance of the training procedure. As previously noted, a memory as disclosed herein may include an area (or areas) that are reserved exclusively for performing reads and writes during performance of the training procedure. Accordingly, data signals written to and read from these reserved areas may be aligned with (and thus synchronized to) the DQS signal.

Another embodiment of a training procedure is outlined below. The following terms are used for describing this particular embodiment of a training procedure. This procedure may be used for setting delays (e.g., preamble/postamble) for signals transmitted to and received from a memory.
TA—Target Address range
TDW—Target Data written or signal sent to dram device
TDR—Target Data read or signal received from dram device
x—current delay value
D—Total range of delay settings
R—Results range corresponding to delays
T—time
EndTrn—End Training
TP—Training time
   Using the terms above, this embodiment of the training procedure may be described in terms of the following steps:
Step 1. Prepare the Training engine
   a. Software sets TP
   b. Software sets EndTrn=Yes
Step 2. Start the Training engine
   a. Software sets TA for Training engine
   b. Software sets TDW to be used for comparison
   c. Set D[x]
   d. Send TDW to TA
   e. Read TDR from TA
   f. Compare TDR with TDW
   g. If the TDR matches TDW then go to step 3
   h. If the TDR does not match TDW go to step 4
Step 3. TDR matches TDW
   a. Set a flag in the R[x] that to indicate that current delay
   b. Check to see if R has all flags set. If yes, then go to step 5. If no, go to step 3c
   c. Increment x
   d. Repeat step 2
Step 4. TDR does not matches TDW
   a. Increment x
Step 5. R has all flags set
   a. The results are analyzed based on TDW
   b. If additional analysis is required then go to Step 2.
   c. The final delay value is set.
   d. Go to step 6.
Step 6. Check CP
   a. If T=CP, go to step 2.
   b. If T not=Cp, go to step 7
Step 7. Check EndTrn
   a. T is incremented
   b. If EndTrn=Yes, then go to step 8
   c. If EndTrn=No, then go to step 6
Step 8 End Training
   a. Exit

It should be noted that the training procedure outlined above is but one possible embodiment. Training procedures that follow a different sequence of steps are possible and contemplated within the scope of this disclosure.

### Method for Event-Driven Training:

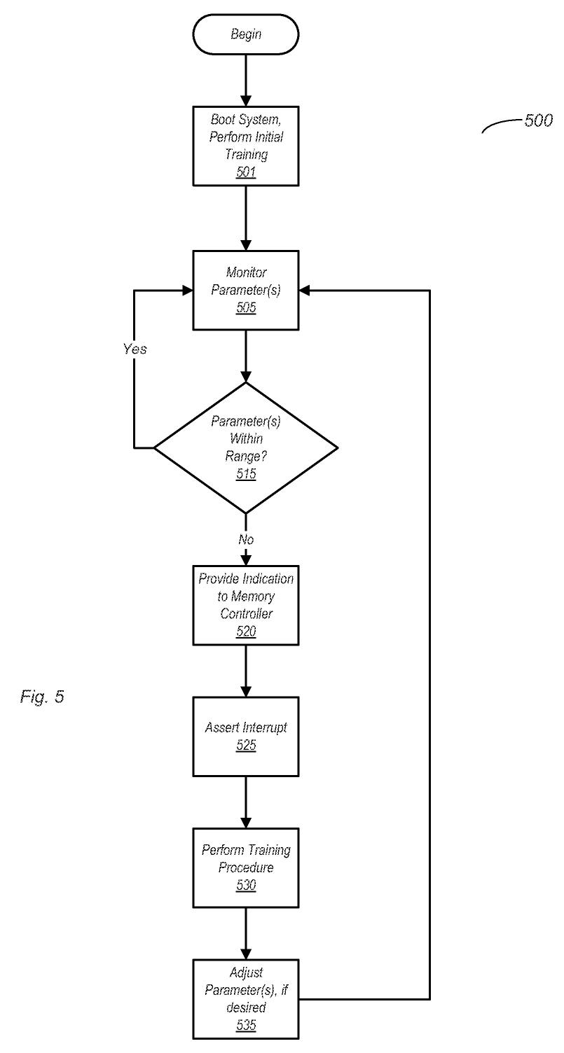

FIG. 5 is a flow diagram illustrating a method of operating one embodiment of a memory subsystem within a computer system. In the embodiment shown, method 500 begins with the booting of the computer system that includes the memory subsystem, wherein a training procedure is performed during the boot up process (block 501). After system boot-up has been completed, various parameters may be monitored (block 505). These parameters may include, but are not limited to, a clock frequency, a supply voltage, temperature readings from the memory, and an amount of time that has elapsed since the most recent performance of the training procedure.

If the monitored parameters are within a specified range (block 515, yes), the monitoring may continue (block 505) without a subsequent performance of the training procedure. However, if one or more monitored parameters is not within a specified range (block 515, no), then additional events that result in the performance of the training procedure may occur.

Responsive to determining that one or more of the parameters is not within its specified range, an indication may be provided to a memory controller (block 520). The memory controller may then respond by asserting a interrupt signal (block 525). A processor may receive the interrupt signal, and may invoke an interrupt handler routing in order to service the interrupt. The interrupt handler routine invoked by the processor may temporarily halt accesses to the memory by programs that were executing at the time the interrupt request was received, as well as other devices in the computer system (e.g., DMA devices). After memory accesses have been temporarily halted, the memory controller may perform the training procedure (block 530). The training procedure may include the performance of a number of write and read operations on the memory, as well as the aligning of various signals to a clock signal and/or a DQS signal, as described above.

After the training procedure is complete, the ranges for some parameters may be adjusted (block 535). For example, as discussed above, a specified range for a supply voltage may be updated responsive to the insertion of a hot-pluggable memory module and the resultant loading on the power supply.

After the training procedure is complete, the interrupt handler may indicate the same. The processor may respond by ending the interrupt handler routine, and may begin allowing operational accesses to the memory by programs and so forth. The method may then return to block 505, wherein the monitoring of various parameters continues.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A memory subsystem comprising:
a memory;
a memory controller coupled to the memory; and
a monitoring unit coupled to the memory controller, wherein the monitoring unit is configured to:
monitor at least one parameter of the memory subsystem;
determine whether the at least one parameter is within a specified range; and
provide an indication to the memory controller if the at least one parameter is not within the specified range;
wherein the memory controller is configured to perform a training procedure responsive to receiving the indication, wherein performing the training procedure includes the memory controller performing at least one write to memory, at least one read from memory, and adjusting a delay for one or more signals conveyed between the memory controller and the memory.

2. The memory subsystem as recited in claim 1, wherein the at least one parameter includes one or more of the following: a clock frequency, a memory supply voltage, a memory temperature.

3. The memory subsystem as recited in claim 1, wherein the memory controller is configured to periodically perform the training procedure.

4. The memory subsystem as recited in claim 1, wherein the memory controller is configured to perform the training procedure responsive to a user request.

5. The memory subsystem as recited in claim 1, wherein the memory includes a plurality of addresses reserved for reading data from and writing data to during the performing of the training procedure, and wherein the memory controller is configured to block access to addresses within the plurality of addresses when the training procedure is not being performed.

6. The memory subsystem as recited in claim 1, wherein the memory controller is configured to assert a signal indicating an interrupt responsive to receiving the indication from the monitoring unit.

7. The memory subsystem as recited in claim 1, wherein performing the training procedure further includes:
synchronizing a data strobe signal to a memory clock signal;
aligning the data strobe signal to a read enable signal;
aligning the data strobe signal to data signals received from the memory; and
aligning the data strobe signal to data signals transmitted to the memory.

8. The memory subsystem as recited in claim 1, wherein the memory is one of the following: a double data rate (DDR) memory, a DDR2 memory, a DDR3 memory.

9. The memory subsystem as recited in claim 1, wherein the memory includes one or more hot-pluggable memory modules.

10. The memory as recited in claim 1, wherein the monitoring unit includes one or more registers configured to store information indicating the specified range for the at least one parameter.

11. A method comprising:
a monitoring unit monitoring at least one parameter of a memory subsystem, the memory subsystem including a memory and a memory controller;
the monitoring unit determining whether the at least one parameter is within a specified range;
the monitoring unit providing an indication to the memory controller if the at least one parameter is not within the specified range; and
the memory controller performing a training procedure responsive to receiving the indication, wherein performing the training procedure includes the memory controller performing at least one write to memory, at least one read from memory, and adjusting a delay for one or more signals conveyed between the memory controller and the memory.

12. The method as recited in claim 11 further comprising performing said training procedure subsequent to performing an initial training procedure during a boot up of a computer system that includes the memory subsystem.

13. The method as recited in claim 11, wherein said monitoring at least one parameter comprises monitoring one or more of a clock frequency, a memory supply voltage, and a memory temperature.

14. The method as recited in claim 11, further comprising performing the training procedure on a periodic basis.

15. The method as recited in claim 11, further comprising performing the training procedure responsive to a user request.

16. The method as recited in claim 11, wherein performing the training procedure includes:
synchronizing a data strobe signal to a memory clock signal;
aligning the data strobe signal to a read enable signal;
aligning the data strobe signal to data signals received from the memory; and
aligning the data strobe signal to data signals transmitted to the memory.

17. A computer system comprising:
at least one processor;
a memory controller coupled to the at least one processor;
a memory coupled to the memory controller; and
a monitoring unit, wherein the monitoring unit is configured to:
monitor at least one parameter associated with the memory;
determine whether the parameter is within a specified range; and
provide an indication to the memory controller if the at least one parameter is not within the specified range;
wherein the memory controller is configured to perform a training procedure responsive to receiving the indication, wherein performing the training procedure includes the memory controller performing at least one write to memory, at least one read from memory, and adjusting a delay for one or more signals conveyed between the memory controller and the memory.

18. The computer system as recited in claim 17, wherein the memory controller is configured to provide an interrupt signal to the at least one processor responsive to receiving the indication from the monitoring unit, and wherein the processor is configured to execute an interrupt handler routine responsive to receiving the signal.

19. The computer system as recited in claim 17, wherein the memory controller is configured to write to and read from a designated range of memory addresses when performing the training procedure, wherein the designated range of addresses is reserved for performing the training procedure, and wherein the memory controller is configured to inhibit reads from and writes to the designated range of addresses when the training procedure is not being performed.

20. The computer system as recited in claim 17, wherein the monitor unit is configured to determine one or more of the following:
if a supply voltage provided to the memory is within a specified voltage range;
if a frequency of a memory clock signal is within a specified frequency range;
if a temperature of the memory is within a specified temperature range.
